(19) United States
(12) Patent Application Publication
(10) Pub. No.: US 2026/0242070 A1
(43) Pub. Date: Aug. 20, 2026

(54) ELECTRIC PROPULSION SYSTEM FOR SPACE APPLICATIONS

(71) Applicant: Forchun, LLC, San Jose, CA (US)

(72) Inventor: MOON CHUN, San Jose, CA (US)

(21) Appl. No.: 18/669,361

(22) Filed: May 20, 2024

Related U.S. Application Data
(60) Provisional application No. 63/468,189, filed on May 22, 2023.

(51) Int. Cl. B64G 1/40; H05H 1/10; H05H 1/46

(52) U.S. Cl. CPC B64G 1/413; H05H 1/10; H05H 1/46

(57) ABSTRACT

Embodiments disclosed herein comprise an apparatus with a first chamber for storing a propellant and a second chamber that is fluidly coupled to the first chamber to allow the propellant to enter the second chamber. In an embodiment, an antenna is adjacent to the second chamber, where the antenna is configured to couple electromagnetic radiation into the second chamber to ionize the propellant into a charge-neutralized plasma, with ions, and electrons. In an embodiment, a grid is at an end of the second chamber opposite from the first chamber, and an annular cavity is coupled to the grid with an opening opposite from the grid. In an embodiment, the annular cavity comprises a first magnet. In an embodiment, a column is within the annular cavity, and the column comprises a second magnet.

### CROSS-REFERENCE TO RELATED APPLICATIONS

This application claims the benefit of U.S. Provisional Application No. 63/468,189, filed on May 22, 2023, the entire contents of which are hereby incorporated by reference herein.

### FIELD OF THE INVENTION

Embodiments disclosed herein relate to electric propulsion systems for space applications.

### BACKGROUND

Spacecrafts and satellite systems are used in various applications, such as communication, Earth observation, and scientific research. Over time, the number of operational satellites and defunct space objects in Earth's orbit has significantly increased, leading to concerns regarding orbital congestion and space debris mitigation. Consequently, the need for effective on-orbit service spacecrafts with advanced propulsion systems has become evident.

The growing capability of small satellites (e.g., satellites weighing less than 100 kilograms) has led to an exponential increase in their numbers in recent years. This trend is predicted to gain further momentum as the costs of launching rockets to orbit continue to decrease. Consequently, there is an increasing demand for on-orbit servicing systems equipped with suitable propulsion systems to effectively manage both operational and non-functioning space objects within Earth's orbit.

Electric propulsion thrusters are beneficial for interplanetary and deep space missions due to their ability to generate significantly higher specific impulse than chemical propulsion thrusters. Moreover, electric propulsion technology is rapidly replacing chemical propulsion technology for in-space applications such as satellite orbit maintenance, orbit changes, and other essential missions involving spacecraft and satellite systems. This shift is primarily attributed to the efficient utilization of propellants by electric propulsion systems.

### BRIEF DESCRIPTIONS OF THE DRAWINGS

FIG. 1A is a partially exploded perspective view illustration of a thruster with a first thruster component coupled to a fuel source and a second thruster component detached from the first thruster component.

FIG. 1B is a perspective view illustration of a thruster with a power processing unit, a propellant chamber, an ionization chamber, a grid, and a magnetic annular cavity, in accordance with an embodiment.

FIG. 2A is a cross-sectional schematic illustration of a thruster, in accordance with an embodiment.

FIG. 2B is a cross-sectional schematic illustration of a thruster, in accordance with an additional embodiment.

FIG. 3A is a cross-sectional illustration of a thruster with a grid that comprises a first plate and a second plate, in accordance with an embodiment.

FIG. 3B is a cross-sectional illustration of a thruster with a grid that comprises a first plate, a second plate, and a third plate, in accordance with an embodiment.

FIG. 4A is a cross-sectional illustration of a portion of a grid that comprises a first plate and a second plate, in accordance with an embodiment.

FIG. 4B is a cross-sectional illustration of a portion of a grid that comprises a first plate, a second plate, and a third plate, in accordance with an embodiment.

FIG. 5A is an exploded perspective view of a propellant chamber with a recess for an antenna and a dielectric window for covering the antenna, in accordance with an embodiment.

FIG. 5B is a cross-sectional illustration of a propellant chamber with a solid propellant, in accordance with an embodiment.

FIG. 5C is a cross-sectional illustration of a propellant chamber with a solid propellant that comprises a first propellant material and a second propellant material, in accordance with an embodiment.

FIG. 6 is a perspective view illustration of an on-orbit servicing spacecraft with a plurality of compartments for deploying thrusters, in accordance with an embodiment.

FIG. 7A is a perspective view illustration of a satellite with an attached thruster, in accordance with an embodiment.

FIG. 7B is a perspective view illustration of a satellite with an attached thruster which is equipped with a solar panel assembly, in accordance with an embodiment.

FIG. 7C is a perspective view illustration of a small-form factor satellite with an attached thruster, in accordance with an embodiment.

FIG. 8 is a process flow diagram depicting a process for stabilizing an object in space with a thruster that comprises a magnetic component and attaching the component to the object, in accordance with an embodiment.

FIG. 9 is a schematic of a computing device that is integrated into a thruster module, in accordance with an embodiment.

### EMBODIMENTS OF THE PRESENT DISCLOSURE

Described herein are electric propulsion systems for space applications, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order to not obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, the electric propulsion technologies for space applications (e.g., on-orbit servicing and/or deep space exploration) are growing in importance as advances in design and efficiency have led to significant improvements compared to chemical propulsion thrusters.

Two main electric propulsion technologies have been developed over the years and have emerged as the most mature and promising options. A first type of electric propulsion thruster is a gridded ion thruster (GIT) and a second type of electric propulsion thruster is a Hall thruster (HT). HTs may also be referred to as Hall Effect Thrusters (HETs). GITs utilize electrostatic acceleration of ions created in the plasma source. The ions in the plasma are propelled by a high electric field that is generated through the application of a bias (or biases) to an electrode grid system in order to provide the desired thrust. In contrast, HTs leverage an electric field crossed with a magnetic field (e.g., an Ex B force), that is formed by orthogonal electric and magnetic fields. The magnetic field traps lightweight electrons which help ionize neutral gas, and the resulting ions are accelerated by the electric field to provide the desired thrust. Both GITs and HTs offer unique advantages and disadvantages as electric propulsion methods for spacecraft and satellites. GITs hold the potential for achieving high exit velocities which are ideal for long-distance missions. However, GITs have a relatively smaller thrust compared to HTs. HTs, on the other hand, generally deliver higher thrust due to their lack of limitations posed by space-charge restrictions in GITs.

For both GITs and HTs, xenon gas is generally used as a propellant due to its heavy atomic mass which increases the effective thrust. The chemically inert nature of xenon helps avoid corrosion or contamination with the rest of spacecraft or satellite components. However, the annual production of xenon gas worldwide is limited (e.g., to about 60 tons), and xenon gas is expensive. In addition to the high cost and the limited production volume worldwide, the xenon gas needs to be compressed with high-pressure gas storage and delivery systems. This adds significant weight and complexity to the spacecraft or satellite systems.

Both GITs and HTs also require a separate electron source to charge-neutralize the energetic ions they extract from the beamline. In particular, HTs must have the cathode electron source to provide the “seed” electrons to ionize the neutral gas to create the plasma besides the need for the charge-neutralization of the energetic ions. HTs are also known to have several instabilities relating to the ionization and the electron-wall interactions during the operation limiting their useful lifetime.

Accordingly, embodiments disclosed herein include an electric propulsion thruster that combines one or more aspects of a GIT with one or more aspects of a HT in order to optimize performance for different operating conditions. Such an electric propulsion thruster may be referred to as a gridded Hall thruster (GHT). The GHT may include a control system that modifies thruster conditions in order to operate the GHT in a GIT mode, a HT mode, or a combination of a GIT mode and a HT mode. For example, a control system may change a bias applied to a grid system in order to modify the flow of the ions from an ionization chamber into an annular magnetic cavity. In some embodiments, the magnetic field strength generated by the annular magnetic cavity can be adjusted when electromagnets are used in the annular magnetic cavity. The flexibility in the operating conditions of the GHT allows for a single thruster design to be used for many different applications. For example, on-orbit servicing of different types of space assets can be accommodated by a single GHT design. Additionally, a single GHT may be able to provide different on-orbit services for a single space asset by modifying the operational mode of the GHT. The same or similar GHT design may also be used for deep space exploration applications.

Embodiments disclosed herein may also include the use of a solid propellant for the GHT. For example, solid iodine and/or naphthalene may be provided in a propellant chamber that is fluidically coupled to the ionization chamber. The solid propellants may sublime into a gas that is fed into the ionization chamber. The use of solid propellants allows for the elimination of high-pressure gas storage and delivery systems. This enables a reduction in the mass of the GHT as well as a reduction in complexity and cost of the GHT. The use of solid propellants also reduces the probability of incurring mechanical damage from excessive vibrations during a rocket launch sequence. Further, the solid propellants are less expensive and more readily available than xenon.

Embodiments disclosed herein also include on-orbit servicing spacecraft that are used to deploy GHTs to space assets, such as satellites or other space objects. For example, the on-orbit servicing spacecraft may navigate to a space asset and perform one or more on-orbit servicing procedures. On-orbit servicing procedures may include processes such as, but not limited to, life extension through the use of the GHT as a replacement (or supplemental) propulsion source for the space asset, space tugging to maintain the orbit or change the orbit attitude of a space asset, deorbiting a defunct space asset, or space debris clearing. In an embodiment, the spacecraft may be equipped with multiple compartments for the GHTs which can be dispensed near space assets. In an embodiment, the servicing spacecraft may be equipped with a communication module, a control module, a navigation module, and a propulsion module (e.g., a GHT). In a particular embodiment, the propulsion module is equipped with a gimbal system that controls the direction of spacecraft to enable navigation through in space.

Embodiments disclosed herein may also comprise one or more processes for stabilizing space assets or other space objects through the use of a GHT. For example, the magnetic components of the GHT can be used to induce eddy-current induced drag force on the space asset or space object. The stabilization may be used in order to improve the coupling process between the GHT and the space asset or space object.

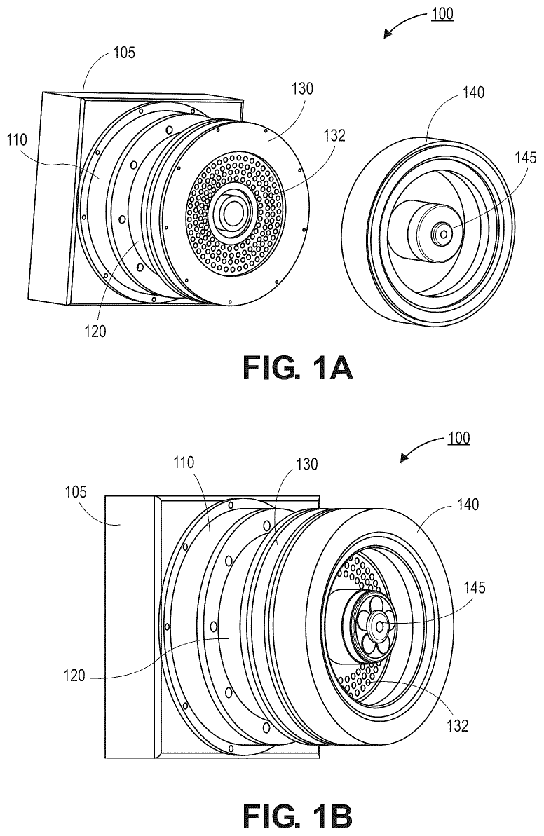

Referring now to FIG. 1A, a partially exploded perspective view illustration of a thruster module 100 is shown, in accordance with an embodiment. In an embodiment, the thruster module 100 may comprise an ionization chamber 120 with an open end that is covered by a grid 130. The grid 130 may comprise one or more plates (described in greater detail below) that each comprise holes 132 through the plates. The one or more plates of the grid 130 are configured to be biased in order to accelerate ions generated in the ionization chamber 120. The ionization chamber 120 and the grid 130 may have functionality that is similar to a GIT device.

In an embodiment, the thruster module 100 may further comprise an annular cavity 140. As used herein, an “annular cavity” may refer to a cylindrical structure with a hole through an entire height of the cylindrical structure. While reference to “annular” and “cylindrical” are used, it is to be appreciated that an “annular cavity” does not need to have a perfectly circular cross-section. In an embodiment, the “annular cavities” described herein may include shell-like structures. For example, an annular cavity may be a shell, and one or more components may be provided within the shell of the annular cavity. For example, the annular cavity 140 may house a magnet (not visible in FIG. 1A), such as an annular magnet, or an assembly of magnets. A central column 145 may also comprise a magnet (not visible in FIG. 1A), or an assembly of magnets. The combination of the two magnets in the annular cavity 140 and the column 145 generate a magnetic field that traps electrons while allowing ions to accelerate in response to an electric field that is substantially orthogonal to the magnetic field. The annular cavity 140 may have functionality that is similar to a HT.

In an embodiment, the ionization chamber 120 may sometimes be referred to as a plasma chamber. The ionization chamber 120 may receive a propellant from a propellant chamber 110. The propellant may be ionized into a plasma through any suitable plasma generation process. For example, cathodic heating of electrons, radio-frequency (RF) heating, microwave heating, or the like may be used to generate a plasma in the ionization chamber. As can be appreciated, the ionization chamber 120 may not be sealed since the thruster module 100 will operate in low pressure (e.g., vacuum or near vacuum) environments, such as space. As used herein, “space” may refer to an altitude above a mean sea level of Earth that is at or above approximately fifty miles. Though, “space” may also refer to any other commonly understood definition, such as an altitude above the Kármán line.

It is to be appreciated that in conventional HTs the ionization zone and the acceleration zone overlap. The overlap of the two zones results in significant plasma-related instabilities such as “breathing mode” and “rotating spokes”. These instabilities can negatively affect the overall lifetime of the HTs. Accordingly, an aspect of embodiments disclosed herein is that the plasma generation zone is separated from the acceleration zone. That is, the ionization chamber 120 and the annular cavity 140 are spaced apart from each other. This provides improved stability and longevity for the thruster module 100.

In an embodiment, the propellant chamber 110 of the thruster module 100 is provided adjacent to the ionization chamber 120. The propellant chamber 110 may be suitable for storing any type of propellant. In a particular embodiment, the propellant chamber 110 is configured to store a solid propellant, such as, but not limited to iodine and/or naphthalene. When a solid propellant is used, the propellant is designed to sublime in order to flow into the ionization chamber 120. That is, the propellant chamber 110 and the ionization chamber 120 are fluidically coupled with each other. In some embodiments, a valve or other fluid flow control system (not shown) is provided between the propellant chamber 110 and the ionization chamber 120 in order to control a flow of propellant gas into the ionization chamber 120. While solid propellants are described in greater detail herein, it is to be appreciated that embodiments may also include a thruster module 100 with a gas or liquid propellant, such as xenon, krypton, argon or the like.

In an embodiment, a power processing unit (PPU) 105 may be integrated as part of the thruster module 100. The PPU 105 may comprise a communication module, a control module, a navigation module, and/or the like. In an embodiment, the control module may include systems for changing thrust values, switching between operating modes (e.g., GIT mode, HT mode, or a combination thereof), changing thrust direction, and/or the like. In an embodiment, the control module of the PPU 105 may initiate such changes by altering one or more biases applied to the grid 130, changing a magnetic field strength (e.g., when the magnets are electromagnets), changing a flow rate of propellant into the ionization chamber 120, changing an amount of power (e.g., RF power or microwave power) coupled to the propellant in the ionization chamber, and/or the like.

Referring now to FIG. 1B, a perspective illustration of the assembled thruster module 100 is shown, in accordance with an embodiment. As shown, the annular cavity 140 and the column 145 are fitted against the grid 130. Accordingly, plasma generated in the ionization chamber 120 will include ions that are accelerated through the grid 130 and into the annular cavity 140. There, a majority of electrons that are present will be captured or trapped by the magnetic field generated by the magnets in the annular cavity 140 and the column 145 while the ions are accelerated through the annular cavity 140 away from the thruster module 100 in order to generate the desired thrust.

More generally, ions or plasma and the neutral gas generated in the ionization chamber 120 are extracted from the ionization chamber 120 through the grid 130 by one or more of electrostatic forces, electromagnetic forces, and/or pressure differential between the ionization chamber 120 and the external vacuum of space. The individual plates (not shown) of the grid 130 may be biased positively, negatively, or grounded depending on the mission requirements. For example, if an in-space mission requires a high exit velocity for long distant travel, a first plate with holes (which is sometimes referred to as a screen grid) may be highly positively biased and a second plate with holes (which is sometimes referred to as an acceleration grid) is negatively biased to increase the ion velocity. In another example, if an in-space mission requires a high thrust with a lower exit velocity (e.g., for maintaining an orbit of a satellite), the first plate with holes may be grounded while the second plate with holes can be positively biased to function as an anode. This allows the charge-neutralized plasma and the neutral gas to pass through the grid 130 and enables operation in the HT mode.

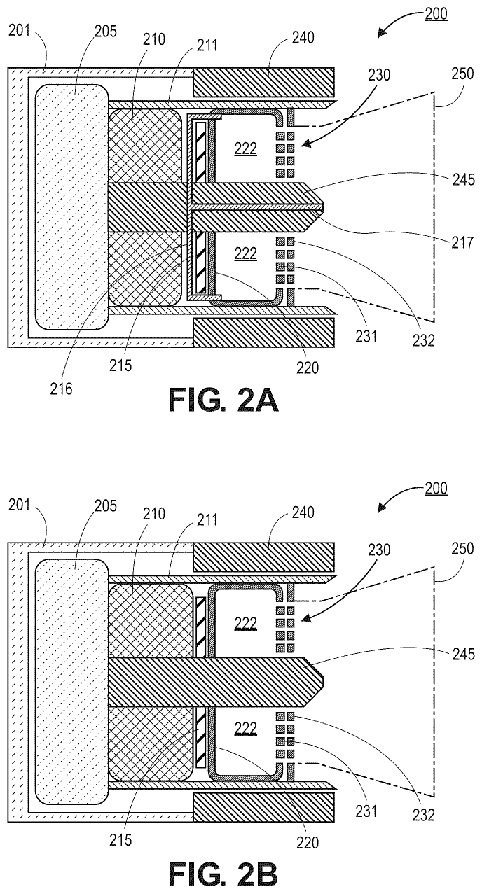

Referring now to FIG. 2A, a cross-sectional schematic illustration of a thruster module 200 is shown, in accordance with an embodiment. In an embodiment, the thruster module 200 may comprise a PPU 205. A propellant chamber 210 may be adjacent to the PPU 205. In an embodiment, the ionization chamber 220 may be adjacent to the propellant chamber 210. In an embodiment, propellant from the propellant chamber 210 may flow into the ionization chamber 220 through a fluidic path (not shown in FIG. 2A). In an embodiment, the ionization chamber 220 may comprise an internal volume 222 for generating plasma.

In an embodiment, the propellant may be ignited into plasma by an antenna 215. For example, the antenna 215 may be provided between the propellant chamber 210 and the ionization chamber 220. Though, the antenna 215 may be located at any suitable location for coupling electromagnetic energy into the ionization chamber 220. For example, the antenna 215 may wrap around the ionization chamber 220. The antenna 215 may be configured for supplying RF energy into the ionization chamber 220 or for supplying microwave energy into the ionization chamber 220 through a dielectric window or medium to transmit the RF or microwave energy from the antenna 215.

As shown, an end of the ionization chamber 220 opposite from the propellant chamber 210 is open to the exterior environment (e.g., space). A portion of the open end of the ionization chamber 220 is covered by a grid 230. As shown, the grid 230 may comprise a first plate 231 and a second plate 232. In the illustrated embodiment, the first plate 231 is part of the structure of the ionization chamber 220. Though, in other embodiments, both the first plate 231 and the second plate 232 are distinct structures from the ionization chamber 220. In an embodiment, the first plate 231 and the second plate 232 comprise holes in order to allow species from the ionization chamber 220 to pass through the grid 230. In an embodiment, the first plate 231 and the second plate 232 are configured to be biased to control the flow of species from the plasma. For example, the PPU 205 may include a controller that is used to set the desired bias of the first plate 231 and the second plate 232. Electrical coupling between the PPU 205 and the grid 230 that enables the biasing is omitted for simplicity. While the grid 230 in FIG. 2A is shown as having a first plate 231 and a second plate 232, it is to be appreciated that the grid 230 may comprise a single plate or more than two plates.

In an embodiment, the annular cavity 240 may extend past the grid 230. In the illustrated embodiment, the annular cavity 240 partially surrounds a portion of the ionization chamber 220 and the grid 230 as well. Though, in other embodiments, the annular cavity 240 begins at the outer surface of the grid 230 (similar to the embodiment shown in FIG. 1B). The annular cavity 240 may comprise an annular magnet. A column 245 may also pass through the propellant chamber 210, the ionization chamber 220 and the grid 230, or the column 245 may begin at the outer surface of the grid 230 (similar to the embodiment shown in FIG. 1B). The column 245 may comprise a magnet as well. In an embodiment, the magnets in the annular cavity 240 and the column 245 may comprise permanent magnets, such as samarium-cobalt magnets or the like. In other embodiments, the magnets in the annular cavity 240 and the column 245 may comprise electromagnets. In the case of electromagnets, the strength of the magnetic field generated by the magnets may be controlled by a controller in the PPU 205.

In an embodiment, the thruster module 200 may also comprise an optional cathode system 216 to inject electrons to assist further ionization of the neutral gas which may be passed through the grid 230. For example, a cathode arm 217 may pass through a center of the column 245 in order to inject electrons within the annular cavity 240. However, other embodiments may include center column 245 that only injects neutral gas into the annular cavity 240 in order to neutralize the extracted ion beam 250 from blowing up. In some instances, the thruster module 200 generates a sufficient density of low energy electrons from one or more of the ionization chamber 220, the grid 230, and/or the wall of the annular cavity 240 so that no separate cathode electron source is necessary. For example, FIG. 2B provides an example of a thruster module 200 where the cathode system 216 is omitted.

In an embodiment, the thruster module 200 may be configured with additional cold gas thrusters (CGTs) or warm gas thrusters (WGTs). Gas for operating the CGTs or WGTs may be provided by compressed gas generated from solid propellants. For example, the gas is produced from the sublimation of the solid propellant by utilizing the heat generated from the antenna 215. In another embodiment, the thruster module 200 may be configured to operate with compressed gas propellants such as xenon, krypton, and argon. In such a situation, the gas may be preheated by the heat generated from the antenna 215 which is designed to provide the energy to ionize the preheated propellant gas.

In an embodiment, the thruster module 200 may include any number of housings, protective layers, insulating layers, magnetic shunting layers, and/or the like. For example, an inner housing 211 may protect portions of the ionization chamber 220, the grid 230, and interior surfaces of the annular cavity 240. An outer housing 201 may provide protection for components, such as the propellant chamber 210 and the PPU 205. While certain housings 211 and 201 are shown in FIGS. 2A and 2B, it is to be appreciated that housings may be omitted, added, or redesigned, depending on the specifications of the thruster module 200.

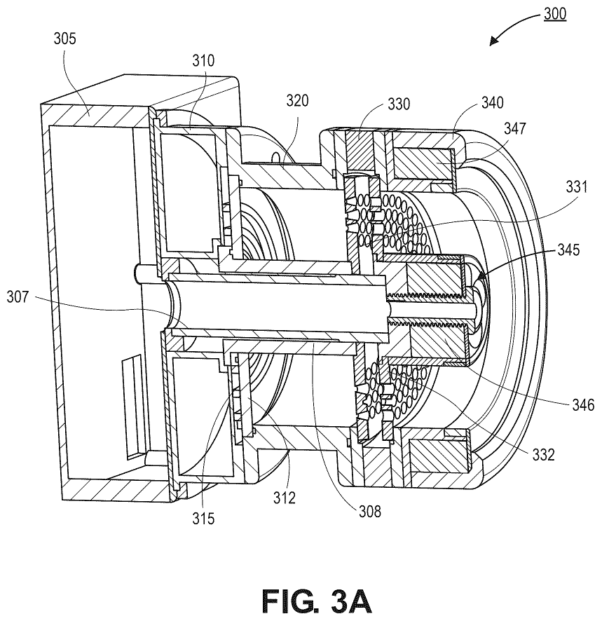

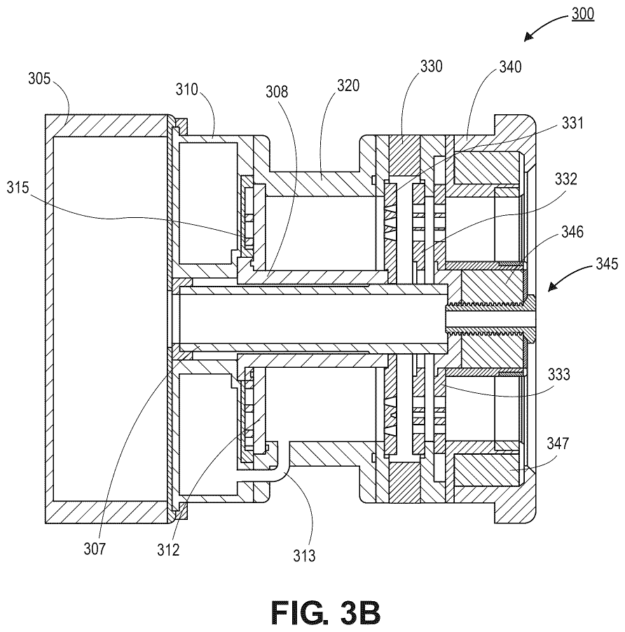

Referring now to FIGS. 3A and 3B, a pair of cross-sectional illustrations of thruster modules 300 is shown, in accordance with additional embodiments. In an embodiment, the thruster module 300 in FIG. 3A comprises a grid 330 with a set of two plates 331 and 332 with holes, and the thruster module 300 in FIG. 3B comprises a grid 330 with a set of three plates 331, 332, and 333 with holes.

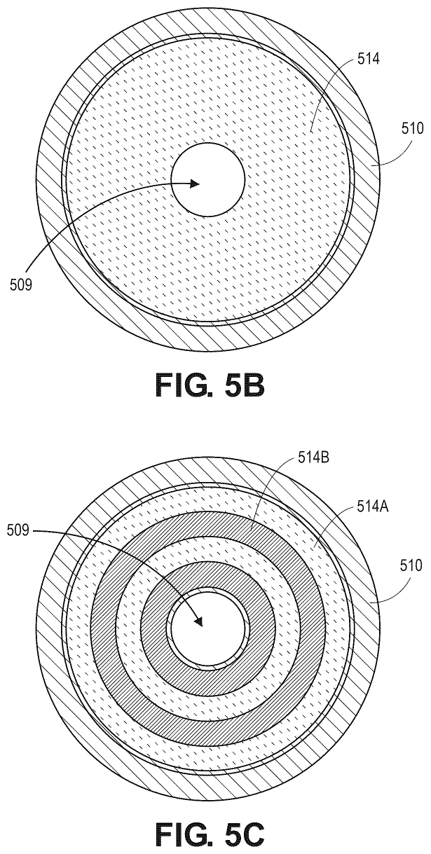

Referring now to FIG. 3A, a cross-sectional illustration of a thruster module 300 is shown, in accordance with an embodiment. In an embodiment, the thruster module 300 may comprise a PPU 305 that is coupled to a propellant chamber 310. In an embodiment, the PPU 305 and the propellant chamber 310 may be similar to any of the PPUs or propellant chambers 310 described in greater detail herein. In an embodiment, an antenna 315 may be set against the propellant chamber 310. The antenna 315 may comprise an RF antenna 315, a microwave antenna 315, or the like. In an embodiment, the antenna 315 is a spiral antenna. A window 312 may be provided over the antenna 315. For example, the window 312 may comprise a dielectric material such as quartz and/or ceramics. A more detailed description of the structure of the propellant chamber 310, the antenna 315, and the window 312 is provided in greater detail below with respect to FIG. 5A.

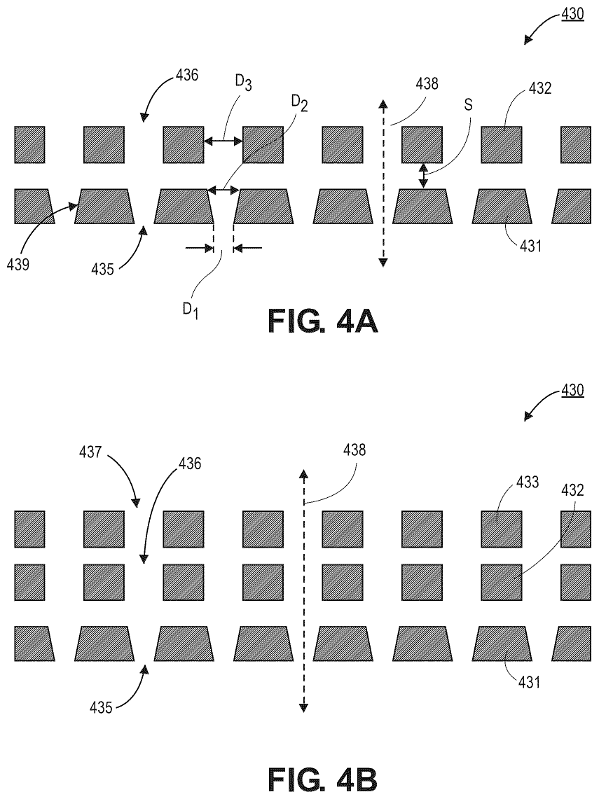

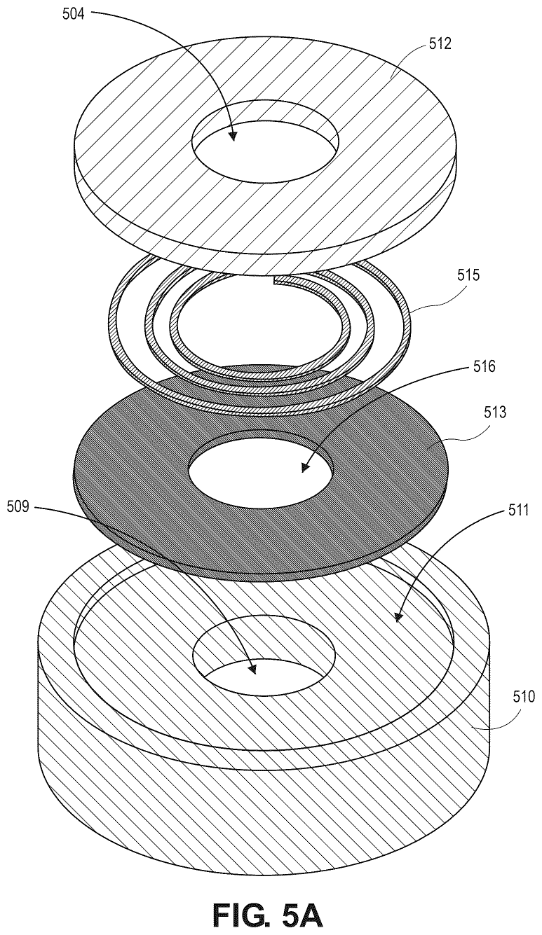

In an embodiment, the ionization chamber 320 may be adjacent to the window 312. For example, the window 312 may seal an end of the ionization chamber 320. In an embodiment, propellant from the propellant chamber 310 may flow into the ionization chamber 320 through a fluidic path (not shown in the plane of FIG. 3A). In an embodiment, the opposite end of the ionization chamber 320 may be covered by the grid 330. In an embodiment, the grid 330 comprises a first plate 331 and a second plate 332. As shown, the holes in the first plate 331 have a non-uniform diameter with a wider opening facing away from the ionization chamber 320. The holes in the second plate 332 may be substantially constant diameter holes. A more detailed description of the grid 330 will be provided in greater detail below with respect to FIGS. 4A and 4B.

In an embodiment, the annular cavity 340 is adjacent to a side of the grid 330 opposite from the ionization chamber 320. The annular cavity 340 may house an annular magnet 347. The annular magnet 347 may be a permanent magnet or an electromagnet. In an embodiment, a column 345 may be provided within the annular cavity 340. The column 345 may be positioned at a center of the annular cavity 340. In an embodiment, the column 345 may comprise a magnet 346, such as a permanent magnet or an electromagnet. The magnet 346 may also be an annular magnet 346 in some embodiments. It is to be appreciated that an “annular magnet” may refer to a single monolithic magnet material that is in a ring-like structure, or an “annular magnet” may refer to a plurality of discrete magnets that are arranged in a ring-like structure. That is, an “annular magnet” may refer to a single magnet or a plurality of magnets.

In an embodiment, an electronics conduit 307 may pass through a portion of the thruster module 300. For example, the electronics conduit 307 may provide a path for electrical coupling between controllers and/or modules of the PPU 305 to other features within the thruster module 300, such as, but not limited to, the grid 330 (e.g., to control biasing of the grid 330), the magnets 346 and/or 347 (e.g., in the case of the magnets 346 and/or 347 being electromagnets), or the like. In an embodiment, the electronics conduit 307 is formed with an insulating material, and the electronics conduit 307 may be isolated from the interior of the ionization chamber 320 by an electrically conductive liner 308.

Referring now to FIG. 3B, a cross-sectional illustration of a thruster module 300 is shown, in accordance with an embodiment. In an embodiment, the thruster module 300 in FIG. 3B may be similar to the thruster module 300 in FIG. 3A, with the exception of several components. For example, the grid 330 in FIG. 3B includes a set of three plates 331, 332, and 333. In an embodiment, the first plate 331 and the second plate 332 may be similar to the first plate 331 and the second plate 332 in FIG. 3A, and the third plate 333 may also have holes with a substantially constant diameter. For example, the diameter of the holes in the third plate 333 may be substantially similar to the diameter of the holes in the second plate. The inclusion of the third plate 333 may be useful for providing additional control of the ions within the thruster module 300 since the additional third plate 333 provides more biasing options for the grid 330.

In an embodiment, the thruster module 300 also depicts a fluidic path 313 between the propellant chamber 310 and the ionization chamber 320. Accordingly, gas from the propellant chamber 310 is able to flow into the ionization chamber 320 for plasma generation. The fluidic path 313 may also comprise one or more valves or other fluid flow control features (not shown) in order to modulate the flowrate of propellant into the ionization chamber 320. While a single fluidic path 313 is shown in FIG. 3B, it is to be appreciated that any number of fluidic paths 313 may be provided in other embodiments. Additionally, while the fluidic path 313 is illustrated as a pipe that extends through a sidewall of the ionization chamber 320, it is to be appreciated that other fluidic coupling options may be used. For example, the window 312 may function as a showerhead or gas distribution assembly in order to distribute propellant into the ionization chamber 320 more uniformly.

Referring now to FIGS. 4A and 4B, a pair of cross-sectional illustrations depicting a portion of different grids 430 is shown, in accordance with an embodiment. The grid 430 in FIG. 4A includes a first plate 431 and a second plate 432, and the grid 430 in FIG. 4B includes a first plate 431, a second plate 432, and a third plate 433.

Referring now to FIG. 4A, a cross-sectional illustration of a portion of a grid 430 is shown, in accordance with an embodiment. In an embodiment, the grid 430 may comprise a first plate 431 with first holes 435, and a second plate 432 with second holes 436. In an embodiment, the first holes 435 may be substantially aligned with the second holes 436. That is, the first holes 435 and the second holes 436 may share common centerlines 438.

In an embodiment, the first holes 435 may have a non-uniform diameter through a thickness of the first plate 431. The first holes 435 may have a first diameter D₁ at one end and a second diameter D₂ at the other end. As shown, the second diameter D₂ is larger than the first diameter D₁. The smaller first diameter D₁ may be closer to the ionization chamber (not shown in FIG. 4A). In an embodiment, the sidewalls 439 of the first holes 435 may be tapered between the first diameter D₁ and the second diameter D₂. For example, an angle of the taper of the sidewalls 439 may be chosen in order to improve ion beam focusing and/or collimation. For example, the taper may be approximately 72° relative to the major surface of the first plate 431. In an embodiment, the second plate 432 may have second holes 436 with a substantially uniform third diameter D₃. In a particular embodiment, the third diameter D₃ is substantially equal to the second diameter D₂. Though, embodiments may also include differences between the second diameter D₂ and the third diameter D₃. In an embodiment the dimensions of the grid 430 may be any suitable dimensions for operating a grid-type thruster system. For example, the diameters D₁-D₃ may be between approximately 1.0 mm and approximately 5.0 mm. Though, larger or smaller diameters may also be used in some embodiments. Additionally, the spacing S between the first plate 431 and the second plate 432 may be between approximately 1.0 mm and approximately 10 mm. Though larger or smaller spacings S may also be used in some embodiments.

Referring now to FIG. 4B, a cross-sectional illustration of a portion of a grid 430 is shown, in accordance with an embodiment. In an embodiment, the grid 430 may comprise a first plate 431 with first holes 435, a second plate 432 with second holes 436, and a third plate 433 with third holes 437. In an embodiment, the first holes 435, the second holes 436, and the third holes 437 may be substantially aligned with each other. That is, the first holes 435, the second holes 436, and the third holes 437 may share common centerlines 438.

In an embodiment, the first plate 431 may include tapered first holes 435, similar to those in FIG. 4A. The second plate 432 may comprise second holes 436 with a uniform diameter through a thickness of the second plate 432, and the third plate 433 may comprise third holes 437 with a uniform diameter through a thickness of the third plate 433. In an embodiment, the diameter of the second holes 436 may be substantially equal to the diameter of the third holes 437. Though, it is to be appreciated that the diameter of the third holes 437 may be different than the diameter of the second holes 436 in some embodiments.

Referring now to FIG. 5A, an exploded perspective view illustration of a propellant chamber 510, a thermally conductive and electrically insulating window 513, an antenna 515, and a dielectric window 512 is shown, in accordance with an embodiment. As shown, the antenna 515 may be a spiral antenna 515 that is positioned between the thermally conductive and electrically insulating window 513 and the dielectric window 512. In some embodiments, the propellant chamber 510 may comprise a recess 511 for accommodating at least a portion of the thickness of a stack including the thermally conductive and electrically insulating window 513, the antenna 515, and the dielectric window 512. As shown, the thermally conductive and electrically insulating window 513 is positioned between the antenna 515 and the recess 511. In an embodiment, a suitable material for the thermally conductive and electrically insulating window 513 may include beryllium oxide, mica, or the like. The thermally conductive and electrically insulating window 513 allows for the transmission of heat generated by the antenna 515 into the propellant chamber 510 (e.g., to improve and/or drive sublimation), while also preventing ends of the antenna 515 from electrically shorting with each other. In an embodiment, the dielectric window 512 may comprise a dielectric material that is substantially transparent to the electromagnetic radiation emitted by the antenna 515, such as quartz or a ceramic. In an embodiment, a hole 509 may also be provided through the propellant chamber 510 in order to accommodate the electrical conduit (not shown in FIG. 5A). The electrical conduit may also pass through a hole 516 in the thermally conductive and electrically insulating window 513 and a hole 504 in the dielectric window 512.

Referring now to FIG. 5B, a cross-sectional illustration of the propellant chamber 510 is shown, in accordance with an embodiment. In an embodiment, the propellant chamber 510 may house a solid propellant 514. The propellant 514 may be a ring of material that can sublime in order to produce a propellant gas that can be fed into the ionization chamber (not shown in FIG. 5B). In an embodiment, the propellant 514 may comprise iodine or naphthalene.

Referring now to FIG. 5C, a cross-sectional illustration of the propellant chamber 510 is shown, in accordance with an additional embodiment. Instead of a single solid propellant 514 material, two or more different propellants 514A and 514B may be provided within the propellant chamber 510. As shown, propellants 514A and 514B are provided in alternating rings around the hole 509. Through control of the surface area of each propellant 514A and 514B, a desired gas mixture of the propellant 514 can be provided to the ionization chamber (not shown in FIG. 5C). While shown in a concentric ring pattern, it is to be appreciated that multiple propellant 514 materials may be arranged within the propellant chamber with any suitable pattern.

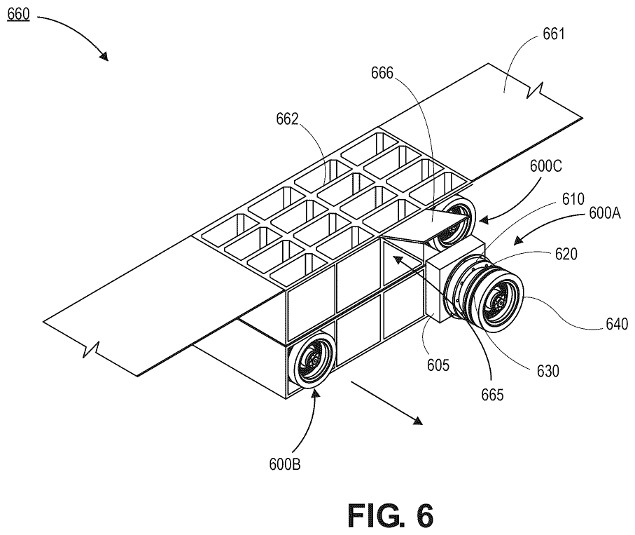

Referring now to FIG. 6, a perspective view illustration of an on-orbit servicing spacecraft 660 is shown, in accordance with an embodiment. In an embodiment, the servicing spacecraft 660 may be used to deploy one or more thruster modules, such as those described herein, to space assets, such as satellites. In an embodiment, the servicing spacecraft 660 may comprise wings 661. The wings 661 may comprise solar cells for powering the servicing spacecraft 660. Solar cells 662 may also be provided on the main body of the servicing spacecraft 660 in some embodiments. In an embodiment, the servicing spacecraft 660 may comprise a plurality of compartments 665 for storing thruster modules 600. For example, thruster modules 600B and 600C are provided in two of the compartments 665. A door 666 or the like may close the compartments 665 until the thruster modules 600 are deployed. The compartments 665 may also comprise a launching mechanism (not shown) to deploy the thruster modules 600, as indicated by the arrow extending out from thruster module 600B.

In an embodiment, one or more thruster modules 600 may be provided on the servicing spacecraft 660 in order to navigate the servicing spacecraft to a particular space asset. For example, thruster module 600A may be used to propel the servicing spacecraft 660. In an embodiment, the thruster module 600A may be similar to any of the thruster modules described in greater detail herein. For example, the thruster module 600A may comprise a PPU 605, a propellant chamber 610, an ionization chamber 620, a grid 630, and magnetic annular cavity 640. In an additional embodiment, the thruster module 600A may be coupled to a gimbal in order to provide directional control of the thrust generated by the thruster module 600A. For example, the gimbal may be a two-axis or three-axis gimbal. In an embodiment, the servicing spacecraft 660 may also be equipped with additional modules such as one or more of a communication module, a control module, a navigation module, and/or the like.

In an embodiment, the servicing spacecraft 660 may navigate to a space assets and/or space objects and deploy thruster modules to perform one or more on-orbit servicing procedures. On-orbit servicing procedures may include processes such as, but not limited to, life extension through the use of the thruster module 600 as a replacement (or supplemental) propulsion source for the space asset, space tugging to maintain the orbit or change the orbit attitude of a space asset, deorbiting a defunct space asset, or space debris clearing.

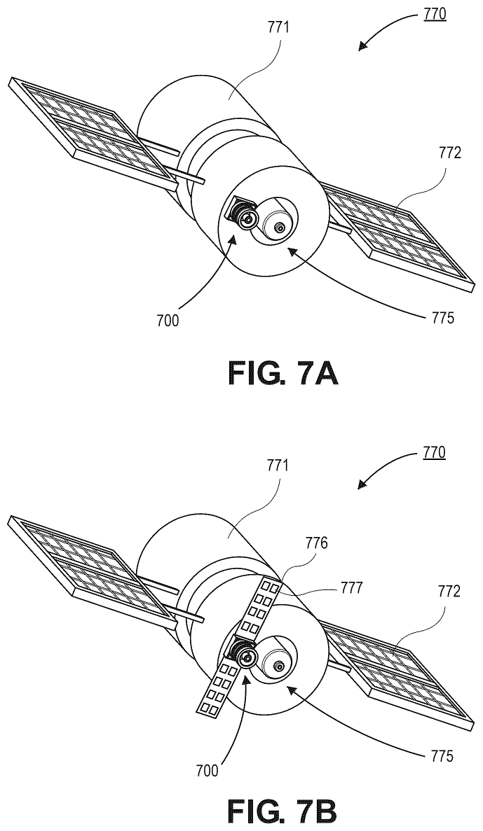

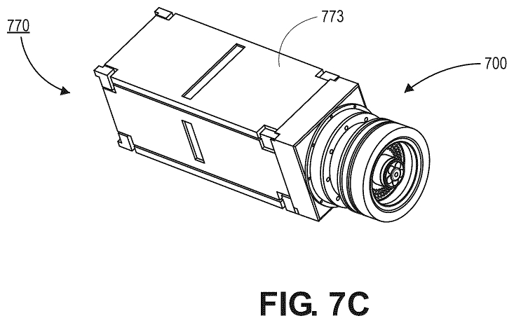

Referring now to FIGS. 7A-7C, perspective illustrations of space assets 770 that are coupled to thruster modules 700 are shown, in accordance with an embodiment. In FIG. 7A, the space asset 770 is a satellite. The satellite may comprise wings 772 with solar panels or the like. The wings may be coupled to a housing 771 that surrounds the interior components of the satellite. In an embodiment, the satellite may comprise an original propulsion device 775. In some embodiments, the original propulsion device 775 has reached an end of life condition, or is otherwise operating sub-optimally. Accordingly, a thruster module 700 has been coupled to the housing 771. For example, a servicing spacecraft similar to servicing spacecraft 660 may approach the satellite and deploy one or more thruster modules 700 to couple to the satellite. In an embodiment, the thruster module 700 may be similar to any of the thruster modules described in greater detail herein. In an embodiment, the thruster module 700 may include a gimbal in order to control the direction of the satellite.

Referring now to FIG. 7B, a space asset 770 that is a satellite similar to the one in FIG. 7A is shown, in accordance with an embodiment. However, the thruster module 700 that is coupled to the satellite includes an integrated power generation solution. For example, the thruster module 700 may comprise wings 776 with solar cells 777. An integrated power generation solution may be beneficial so that the thruster module 700 does not need to rely on the power source of the space asset 770. This can simplify the coupling process between the thruster module 700 and the space asset 770 since an electrical connection between the two may not be necessary. Accordingly, even if the space asset 770 was not originally designed to be compatible with the thruster module 700, the thruster module 700 can still be coupled and provide thrust and navigation for the space asset 770. Additionally, the integrated power generation solution allows for coupling to space assets 770 that may have damaged power supplies, depleted power supplies, or no power supplies.

Referring now to FIG. 7C, a perspective view illustration of a space asset 770 that is a small form factor satellite is shown, in accordance with an embodiment. The small form factor satellite may be a cube satellite or the like. In an embodiment, a thruster module 700 may be coupled to the housing 773 in order to provide propulsion to the small form factor satellite. In an embodiment, the thruster module 700 may include a gimbal in order to control the direction of the small form factor satellite. That is, thruster modules 700 described herein can be scaled to provide the necessary thrust to provide on-orbit servicing for space assets of various sizes and masses.

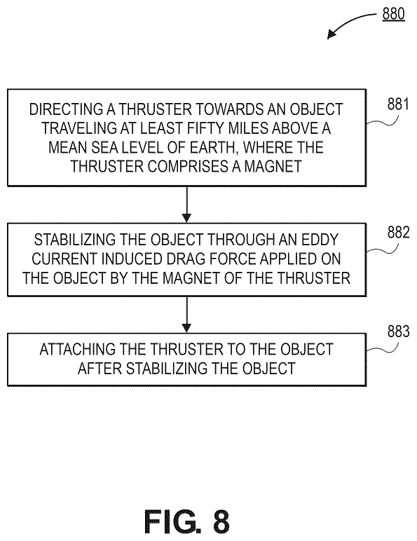

Referring now to FIG. 8, a process flow diagram of a process 880 for stabilizing a space object with a thruster module is shown, in accordance with an embodiment. Stabilizing space objects can be beneficial for several reasons. One of which is to be able to safely couple a thruster module, such as any of those described in greater detail herein, to the space object. Some space objects, especially the defunct satellites, rocket boosters, or space debris may move erratically in tumbling motion and at a high speed in space. As such, initiating coupling for servicing these objects may be difficult. Accordingly, embodiments may utilize the magnetic system of the thruster module to initiate a stabilizing process for the space object through the use of eddy-current induced drag force. Eddy current induced drag force, Fa is defined in Equation 1.

$${F}_{d} = α σ δ {B}_{0}^{2} A v \qquad Equation 1$$

In Equation 1, α is a shape factor related to the pole force of the magnet, σ is the conductivity of the metal of the space object being stabilized, δ is the thickness of the metal of the space object being stabilized, B₀ is the field strength in the gap between two magnet polarities, A is the area of the pole face of the magnet, and v is the relative velocity between the magnets and the conductor (i.e., the metal surface of the space object). As can be appreciated from Equation 1, the faster the space object is tumbling with respect to the magnet system of the thruster module, the stronger the drag force to slow down the tumbling action. Ultimately, the space object will reach a standstill with respect to the thruster module so that the tumbling space object can be mated (e.g., mechanically, electrostatically, or the like) with the thruster module.

In an embodiment, the process 880 may begin with operation 881, which comprises directing a thruster towards an object traveling at least fifty miles above a mean sea level of Earth. In an embodiment, the thruster comprises a magnet. In a particular embodiment, the thruster may be similar to any of the thruster modules described in greater detail herein. For example, the thruster may comprise a grid and an annular magnet. The thruster may be directed towards the object by an on-orbit servicing spacecraft similar to servicing spacecraft 660 described in greater detail herein. The object may be any space asset, such as a satellite or the like. The object may also be any sort of space debris. In an embodiment, the object comprises an electrically conductive surface, such as aluminum.

In an embodiment, the process 880 may continue with operation 882, which comprises stabilizing the object through an eddy current induced drag force applied on the object by the magnet of the thruster. The stabilizing process may continue until the object is substantially at a standstill with respect to the thruster.

In an embodiment, the process 880 may continue with operation 883, which comprises attaching the thruster to the object after stabilizing the object. The thruster may be coupled to the object with any mechanical and/or electrostatic coupling mechanism.

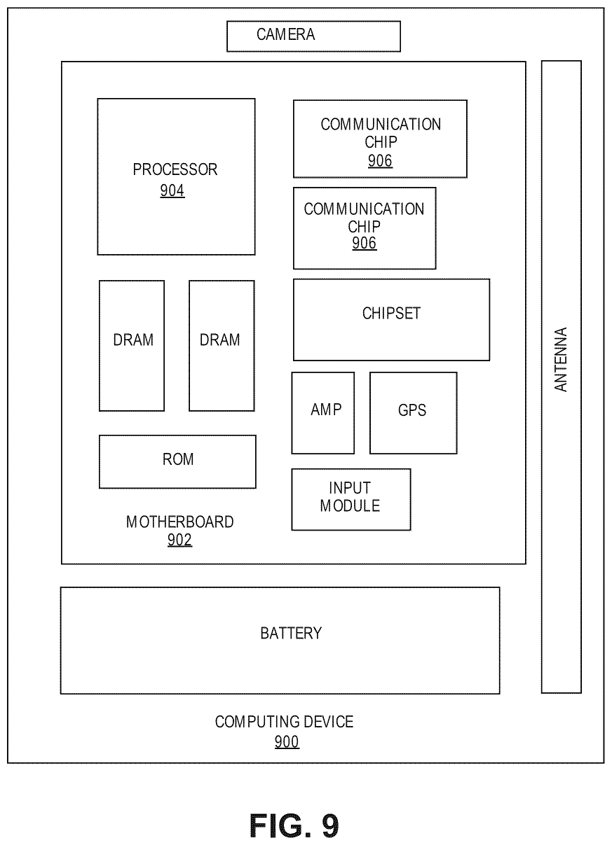

FIG. 9 illustrates a computing device 900 in accordance with one implementation of the disclosure. In an embodiment, the computing device 900 may be integrated into any of the thruster modules described herein. For example, the computing device 900 may be located within a PPU and used for controlling one or more operations, settings, and/or other parameters of the thruster module. The computing device 900 houses a board 902. The board 902 may include a number of components, including but not limited to a processor 904 and at least one communication chip 906. The processor 904 is physically and electrically coupled to the board 902. In some implementations the at least one communication chip 906 is also physically and electrically coupled to the board 902. In further implementations, the communication chip 906 is part of the processor 904.

These other components include, but are not limited to, volatile memory (e.g., DRAM), non-volatile memory (e.g., ROM), flash memory, a digital signal processor, a chipset, an antenna, a battery, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus, comprising: a first chamber for storing a propellant; a second chamber fluidly coupled to the first chamber to allow the propellant to enter the second chamber; an antenna adjacent to the second chamber, wherein the antenna is configured to couple electromagnetic radiation into the second chamber to ionize the propellant into a charge-neutralized plasma, with ions, and electrons; a grid at an end of the second chamber opposite from the first chamber; an annular cavity coupled to the grid with an opening opposite from the grid, wherein the annular cavity comprises a first magnet; and a column within the annular cavity, wherein the column comprises a second magnet.

Example 2: the apparatus of Example 1, wherein the grid comprises a first plate and a second plate.

Example 3: the apparatus of Example 2, wherein the first plate comprises a plurality of first holes that are tapered with a narrow end with a first diameter facing towards the second chamber and a wide end with a second diameter facing the second plate, and wherein the second plate comprises a plurality of second holes with a third diameter that is substantially equal to the second diameter.

Example 4: the apparatus of Example 3, wherein the grid further comprises a third plate with a plurality of third holes, wherein the plurality of third holes have the third diameter.

Example 5: the apparatus of Examples 1-4, wherein the first magnet and the second magnet are permanent magnets.

Example 6: the apparatus of Examples 1-5, wherein the first magnet and the second magnet are electromagnets.

Example 7: the apparatus of Examples 1-6, wherein the antenna is configured to emit RF radiation or microwave radiation.

Example 8: the apparatus of Example 7, wherein the antenna is separated from the second chamber by a window, wherein the window comprises a dielectric material.

Example 9: the apparatus of Examples 1-8, wherein the first chamber is configured to store the propellant as a solid, and wherein the propellant sublimes in order to flow into the second chamber.

Example 10: the apparatus of Examples 1-9, wherein the apparatus is an ion thruster.

Example 11: an apparatus, comprising: a chamber with an open end; a grid to cover the open end of the chamber; and an annular cavity coupled to the grid, wherein the annular cavity comprises a first magnet; and a second magnet surrounded by the first magnet.

Example 12: the apparatus of Example 11, further comprising: a propellant storage chamber fluidically coupled to the chamber.

Example 13: the apparatus of Example 11 or Example 12, wherein the first magnet and the second magnet are permanent magnets or electromagnets.

Example 14: the apparatus of Examples 11-13, wherein the grid comprises: a first plate with a plurality of first holes, wherein one or more of the plurality of first holes have a non-uniform diameter through a thickness of the first plate; and a second plate with a plurality of second holes, wherein one or more of the plurality of second holes have a constant diameter through a thickness of the second plate.

Example 15: the apparatus of Examples 11-14, wherein the chamber is an ionization chamber configured to generate charge-neutralized plasma, with ions, and electrons.

Example 16: the apparatus of Examples 11-15, wherein the grid is configured to be selectively biased by a controller to enable operation of the apparatus in a gridded ion thruster mode, a Hall thruster mode, or a combination of a gridded ion thruster mode and a Hall thruster mode.

Example 17: an apparatus, comprising: a controller; a propellant chamber; an ionization chamber configured to generate charge-neutralized plasma, with ions, and electrons from a propellant stored in the propellant chamber; a grid at an open end of the ionization chamber, wherein the grid is configured to control a flow of ions out of the ionization chamber; and an annular magnet adjacent to an end of the grid opposite from the ionization chamber, wherein the annular magnet is configured to trap electrons and accelerate ions out of the apparatus.

Example 18: the apparatus of Example 17, wherein the controller is configured to control a bias of the grid.

Example 19: the apparatus of Example 17 or Example 18, wherein the apparatus is coupled to a spacecraft.

Example 20: the apparatus of Examples 17-19, wherein the apparatus is configured to self-neutralize a generated ion beam with electrons from the grid and a wall of an annular cavity around the annular magnet.

What is claimed is:

1. An apparatus, comprising:
a first chamber for storing a propellant;
a second chamber fluidly coupled to the first chamber to allow the propellant to enter the second chamber;
an antenna adjacent to the second chamber, wherein the antenna is configured to couple electromagnetic radiation into the second chamber to ionize the propellant into a charge-neutralized plasma, with ions, and electrons;
a grid at an end of the second chamber opposite from the first chamber;
an annular cavity coupled to the grid with an opening opposite from the grid, wherein the annular cavity comprises a first magnet; and
a column within the annular cavity, wherein the column comprises a second magnet.

2. The apparatus of claim 1, wherein the grid comprises a first plate and a second plate.

3. The apparatus of claim 2, wherein the first plate comprises a plurality of first holes that are tapered with a narrow end with a first diameter facing towards the second chamber and a wide end with a second diameter facing the second plate, and wherein the second plate comprises a plurality of second holes with a third diameter that is substantially equal to the second diameter.

4. The apparatus of claim 3, wherein the grid further comprises a third plate with a plurality of third holes, wherein the plurality of third holes have the third diameter.

5. The apparatus of claim 1, wherein the first magnet and the second magnet are permanent magnets.

6. The apparatus of claim 1, wherein the first magnet and the second magnet are electromagnets.

7. The apparatus of claim 1, wherein the antenna is configured to emit RF radiation or microwave radiation.

8. The apparatus of claim 7, wherein the antenna is separated from the second chamber by a window, wherein the window comprises a dielectric material.

9. The apparatus of claim 1, wherein the first chamber is configured to store the propellant as a solid, and wherein the propellant sublimes in order to flow into the second chamber.

10. The apparatus of claim 1, wherein the apparatus is an ion thruster.

11. An apparatus, comprising:
a chamber with an open end;
a grid to cover the open end of the chamber; and
an annular cavity coupled to the grid, wherein the annular cavity comprises a first magnet; and
a second magnet surrounded by the first magnet.

12. The apparatus of claim 11, further comprising:
a propellant storage chamber fluidically coupled to the chamber.

13. The apparatus of claim 11, wherein the first magnet and the second magnet are permanent magnets or electromagnets.

14. The apparatus of claim 11, wherein the grid comprises:
a first plate with a plurality of first holes, wherein one or more of the plurality of first holes have a non-uniform diameter through a thickness of the first plate; and
a second plate with a plurality of second holes, wherein one or more of the plurality of second holes have a constant diameter through a thickness of the second plate.

15. The apparatus of claim 11, wherein the chamber is an ionization chamber configured to generate charge-neutralized plasma, with ions, and electrons.

16. The apparatus of claim 11, wherein the grid is configured to be selectively biased by a controller to enable operation of the apparatus in a gridded ion thruster mode, a Hall thruster mode, or a combination of a gridded ion thruster mode and a Hall thruster mode.

17. An apparatus, comprising:
a controller;
a propellant chamber;
an ionization chamber configured to generate charge-neutralized plasma, with ions, and electrons from a propellant stored in the propellant chamber;
a grid at an open end of the ionization chamber, wherein the grid is configured to control a flow of ions out of the ionization chamber; and
an annular magnet adjacent to an end of the grid opposite from the ionization chamber, wherein the annular magnet is configured to trap electrons and accelerate ions out of the apparatus.

18. The apparatus of claim 17, wherein the controller is configured to control a bias of the grid.

19. The apparatus of claim 17, wherein the apparatus is coupled to a spacecraft.

20. The apparatus of claim 17, wherein the apparatus is configured to self-neutralize a generated ion beam with electrons from the grid and a wall of an annular cavity around the annular magnet.
